(19) United States
(12) Patent Application Publication
(10) Pub. No.: US 2017/0325137 A1
(43) Pub. Date: Nov. 9, 2017

(54) OPTIMIZED CELL UPDATE FOR MULTI CONNECTIVITY

(71) Applicant: Nokia Technologies Oy, Espoo (FI)

(72) Inventors: Guillaume Decarreau, Munich (DE); Sheyam Lal Dhomeja, Espoo (FI); Amaanat Ali, Espoo (FI); Bindhya Vashini Tiwari, Espoo (FI)

(21) Appl. No.: 15/498,950

(22) Filed: Apr. 27, 2017

(30) Foreign Application Priority Data
May 9, 2016 (IN) 201641016152

(51) Int. Cl. H04W 36/00; H04W 36/08; H04W 36/32; H04W 76/02

(52) U.S. Cl. CPC H04W 36/0077; H04W 76/025; H04W 36/08; H04W 36/32

(57) ABSTRACT

Systems, methods, apparatuses, and computer program products for optimized cell update for a multi-connectivity user equipment are provided. One method includes, when a new cell of a second radio interface is selected according to cell reselection parameters provided in a system information block, sending a message, by the user equipment, to inform the network of cell update via a connection on a first radio interface. The user equipment is radio resource control (RRC) connected, the user equipment is connected to a first cell in the first radio interface and is connected to a second cell in the second radio interface.

### CROSS-REFERENCE TO RELATED APPLICATION

This application is related to and claims the benefit and priority of India Patent Application No. 201641016152, filed May 9, 2016, the entirety of which is hereby incorporated herein by reference.

### BACKGROUND

### Field

Embodiments of the invention generally relate to wireless communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), and/or 5G radio access technology. In particular, some embodiments may relate to an apparatus and method of optimized cell update for multi-connectivity.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided by an evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while maintaining backward compatibility. One of the key features of LTE-A, introduced in LTE Rel-10, is carrier aggregation, which allows for increasing the data rates through aggregation of two or more LTE carriers.

5^{th} generation wireless systems (5G) refers to the new generation of radio systems and network architecture. 5G is expected to provide higher bitrates and coverage than the current LTE systems. Some estimate that 5G will provide bitrates one hundred times higher than LTE offers. 5G is also expected to increase network expandability up to hundreds of thousands of connections. The signal technology of 5G is anticipated to be improved for greater coverage as well as spectral and signaling efficiency.

### SUMMARY

One embodiment is directed to a method in a communications network. The method may include, when a new cell of a second radio interface is selected according to cell reselection parameters provided in a system information block, sending a message, by a user equipment, to inform the network of cell update via a connection on a first radio interface. The user equipment is radio resource control (RRC) connected, and the user equipment is connected to a first cell in the first radio interface and is connected to a second cell in the second radio interface.

Another embodiment is directed to an apparatus, which may include at least one processor and at least one memory including computer program code. The at least one memory and computer program code are configured, with the at least one processor, to cause the apparatus at least to, when a new cell of a second radio interface is selected according to cell reselection parameters provided in a system information block, send a message to inform a network of cell update via a connection on a first radio interface. The apparatus is radio resource control (RRC) connected, and the apparatus is connected to a first cell in the first radio interface and is connected to a second cell in the second radio interface.

Another embodiment is directed to an apparatus that includes, when a new cell of a second radio interface is selected according to cell reselection parameters provided in a system information block, transmitting means for sending a message to inform a network of cell update via a connection on a first radio interface. The apparatus is radio resource control (RRC) connected, and the apparatus is connected to a first cell in the first radio interface and is connected to a second cell in the second radio interface.

Another embodiment is directed to a computer program, embodied on a non-transitory computer readable medium. The computer program is configured to control a processor to perform a process that includes, when a new cell of a second radio interface is selected according to cell reselection parameters provided in a system information block, sending a message, by a user equipment, to inform the network of cell update via a connection on a first radio interface. The user equipment is radio resource control (RRC) connected, and the user equipment is connected to a first cell in the first radio interface and is connected to a second cell in the second radio interface.

### BRIEF DESCRIPTION OF THE DRAWINGS

For proper understanding of the invention, reference should be made to the accompanying drawings, wherein:

FIG. 1 illustrates an example diagram depicting RRC States and State Transitions;

FIG. 2 illustrates a signaling flow diagram, according to one embodiment;

FIG. 3a illustrates a block diagram of an apparatus, according to one embodiment;

FIG. 3b illustrates a block diagram of an apparatus, according to another embodiment;

FIG. 4a illustrates a flow diagram of a method, according to one embodiment; and

FIG. 4b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for optimized cell update for multi-connectivity, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

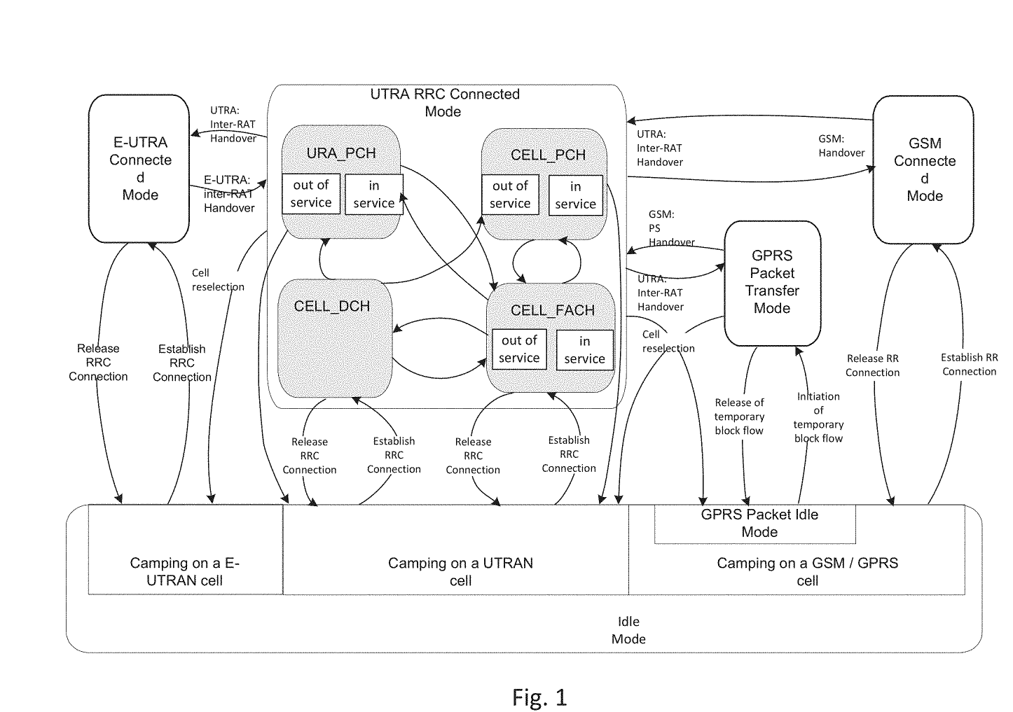

In Wideband Code Division Multiple Access (3G) technology, in radio access, the UE can be in two modes: idle mode or radio resource control (RRC) connected mode. When the UE is in RRC connected mode, it could be in the following states: URA_PCH, CELL_PCH (Cell Paging Channel), CELL_FACH (Cell Forward Access Channel), or CELL_DCH (Cell Dedicated Channel). FIG. 1 illustrates an example diagram depicting RRC States and State Transitions including GSM and E-UTRA. 3GPP technical specification (TS) 25.331 includes further description of the states, and is hereby incorporated by reference in its entirety.

In CELL_PCH or CELL_FACH, the UE is performing cell selection where it camps on the best cell from radio point of view and autonomously selects it. In CELL_DCH state, the mobility is handled by the network, where the UE reports measurements on neighboring cells to the network and the network orders handovers to the UE.

In LTE, there is only one state in RRC connected mode. In this mode, as in CELL_DCH state, the mobility is handled by the network, relying on UE measurement reports.

In LTE, or in 3G when the UE is in CELL_DCH state, if the UE loses the radio connection with the network, a Radio Link Failure (RLF) is declared and the UE stops communicating with the cell. The UE then needs to find a suitable cell and send a message to recover from the loss of connection. This is described for LTE in 3GPP TS 36.300 (Section 10.1.6 Radio Link Failure).

In 5G networks, it is assumed that there will be different Radio Interfaces (RI), including Millimetre Wave (mmW), Centimetre Wave (cmW), and below 6 GHz (B6G). It is also foreseen that there will be “multi-connectivity,” in which the UE may be connected to different RI at the same time. For example, the UE could be connected to mmW for throughput and in B6G for coverage. However, this is not seen as a mandatory permanent state for all UE.

Multi-connectivity may apply, for example, in the following different cases: unique RRC connection and/or multiple RRC connection. In the unique RRC connection, the UE has only one RRC connection with the network, but can be in different RRC states simultaneously in different radio interface. In multiple RRC connection, the UE has multiple RRC connection, for example one per radio interface. The UE can be in different RRC states simultaneously as well.

In an embodiment, the RRC states for the UE may be RRC_SYNC (RRC Synchronized) and/or RRC_PCH (RRC Paging Channel). In RRC_SYNC, the UE is RRC connected, and it is connected to at least a cell and is synchronized with it. Mobility is handled by the network via handovers. The RRC_SYNC state may correspond to CELL_DCH in 3G or RRC_Connected in LTE, or could be referred as active RI in 5G.

In RRC_PCH, the UE is RRC Connected (there is a UE context in RAN), but the UE performs cell reselection for mobility. It may be assumed that the UE performs cell update each time it changes cell. The RRC_PCH state may correspond to CELL_PCH in 3G networks, or could be referred to as inactive RI in 5G.

As discussed above, in 5G networks, it is assumed that there will be different Radio Interfaces (RI), such as Millimetre Wave (mmW), Centimetre Wave (cmW), or Below 6 GHz (B6G). hi addition, the UE may be connected to different RI at the same time, which may be referred to as multi-connectivity. For example, the UE could be connected to mmW for throughput and in B6G for coverage (i.e., similar so Dual Connectivity in LTE). The notion of Radio Interface can be extended to radio access technology (RAT), for example a RI could be LTE and the other one is 5G mmW.

Certain embodiments consider the following example scenario: UE is connected to RI1, in RRC_Sync state; UE is connected to RI2, in RRC_PCH state; and UE is moving and changes cell in RI2. For example, the UE was in Cell 2 and now reselects Cell 3. Thus, the UE has to perform “Cell Update” in order to notify the network that it has now selected Cell 3. This is needed if, for example, the network wants to send a paging to the UE or the network needs to allocate a new set of identities so that communication may seamlessly start in the new cell at a later point of time.

In order to send the “Cell update” message, the UE has to perform random access channel (RACH) access, which is not only costly in term of interferences, but also scarce resource Furthermore, the RACH has to be contention based because cell 3 does not expect the UE. On the other hand, the UE is connected to RI1 and can send uplink (UL) data and receive downlink (DL) data.

According to embodiments of the invention, an inactive RI can be maintained in connected mode inactive state without allocating uplink/downlink capacity in the cells corresponding to the RI while still allowing full mobility. In an embodiment, inactive RI specific mobility procedures are configured to be triggered using the active RI. Additionally, in one embodiment, active RI is responsible to forward the RRC containers (like a proxy) for the RI specific mobility procedures (including reconfiguration messages) to the node handling the mobility procedures.

According to an embodiment, the UE may be RRC connected and performing Cell Reselection for mobility (RRC_PCH) in a specific RI (e.g., RI2), and having UL/DL traffic on another RI (e.g., RI1). In this embodiment, when UE is performing Cell Reselection in RI2, it should stay in the RI2 and should not select a cell in another RI. When a new cell is selected according to cell reselection parameters provided in Cell's SIB, the UE may inform the network via the connection on RI1 (e.g., Cell Update or equivalent new message). The network responds with the Cell updated using the same RI2. In another example embodiment, when the UE informs the network about the selection of the new Cell, the network provides the UE with RACH prefix in order to perform a contention less RACH in RI2 to the newly selected cell and the network may also assign an uplink grant which the UE may use to send further RRC messages to the cell in RI2 for completing the mobility procedure.

It should be noted that, in certain embodiments, RI can be understood as a subdivision of a RAT (e.g., mmW, cmW, B6G) but also as a RAT (e.g. UMTS, LTE).

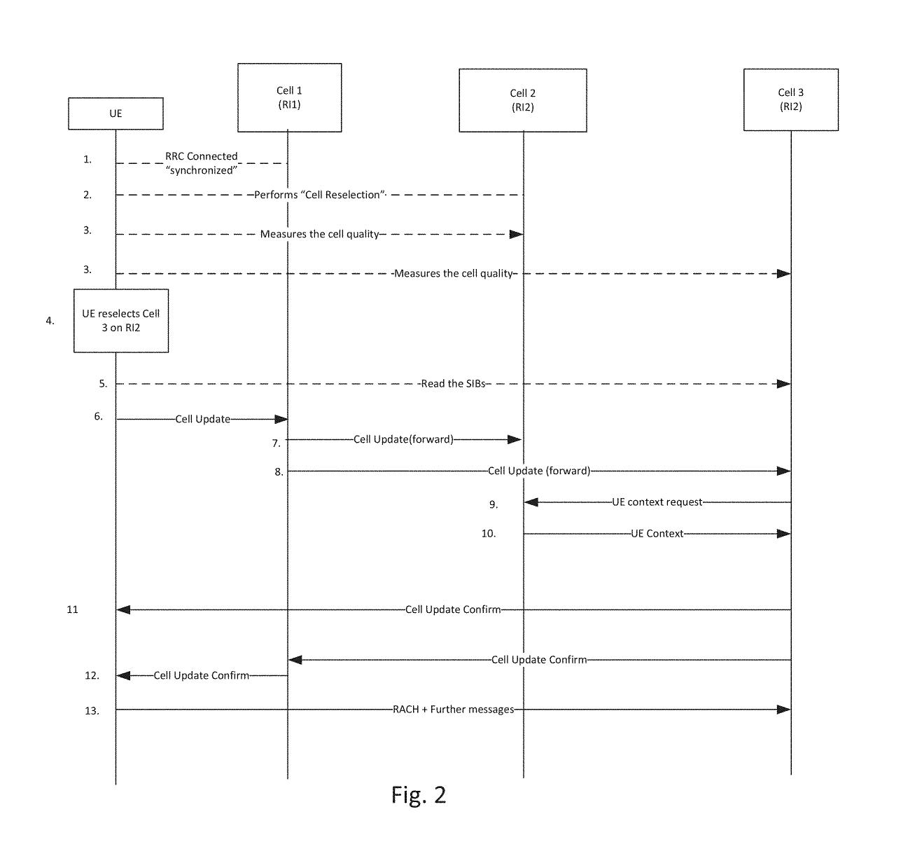

FIG. 2 illustrates an example signaling flow diagram, according to one embodiment of the invention. As illustrated in the example of FIG. 2, at 1, the UE is connected to Cell1 in Radio Interface 1, in RRC_SYNC state. At 2, the UE is connected to Cell 2 in Radio Interface 2, in RRC_PCH state. The UE may use the Cell reselection parameters broadcasted in the SIBs of Cell3. At the time the UE enters RRC_PCH state in RI2, it is clear how the mobility procedures will be handled. For instance, the rules may be informed to the UE with dedicated signaling at an earlier period of time.

Continuing with FIG. 2, at 3, the UE may perform measurements of cell quality on Cell 2 and neighbouring cell 3. At 4, the UE may select Cell3. The UE may read the SIBs of Cell 3, at 5.

The UE may send, at 6, a Cell Update message about the reselection of Cell 3 to Cell1 through RI1. Optionally, at 7, the Cell Update message may be forwarded to Cell2. At 8, the Cell Update message is forwarded to Cell3. Then, at 9, Cell 3 may send a UE context request to Cell 2. At 10, Cell2 may send the UE context to Cell 3. The Cell Update procedure may be completed using the resources in RI2 and, at 11, the cell update confirm message is sent to the UE. This message may contain some RACH preamble and UL grant for the UE to use in the Cell3. Alternatively, the cell update confirm message can be sent to the UE via RI1 where, at 12, the message is first sent from Cell3 to Cell1 then sent to the UE by Cell1. At 13, UE may perform a contention-less RACH to Cell 3 to send further information. It can also use the UL grants provided in earlier message.

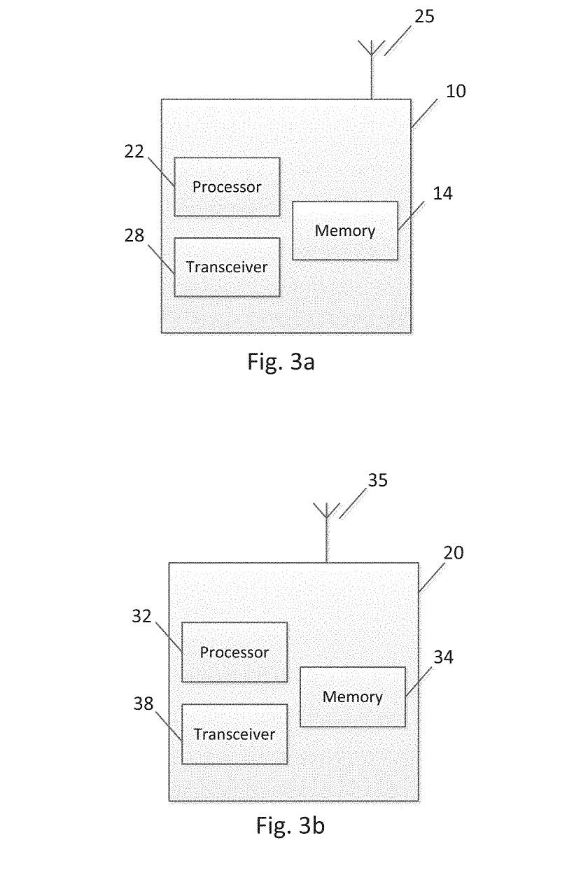

FIG. 3a illustrates an example of an apparatus 10 according to an embodiment. In an embodiment, apparatus 10 may be a node, host, or server in a communications network or serving such a network. For example, in certain embodiments, apparatus 10 may be a network access node or network entity for a radio access network, such as LTE or LTE-A. Thus, in certain embodiments, apparatus 10 may be a base station or eNB. However, in other embodiments, apparatus 10 may be other components within a radio access network. It should be noted that one of ordinary skill in the art would understand that apparatus 10 may include components or features not shown in FIG. 3a.

As illustrated in FIG. 3a, apparatus 10 includes a processor 22 for processing information and executing instructions or operations. Processor 22 may be any type of general or specific purpose processor. While a single processor 22 is shown in FIG. 3a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to an embodiment, apparatus 10 may be a network node or network entity, such as a base station or eNB, for example. In one embodiment, apparatus 10 may be the access node (i.e., eNB) for cell 1, cell 2, and/or cell 3, as illustrated in FIG. 2 discussed above. According to certain embodiments, apparatus 10 may be controlled by memory 14 and processor 22 to, when a new cell is selected according to cell reselection parameters provided in a system information block, receive a message from a UE to inform apparatus 10 of a cell update via a connection on a first radio interface. hi an embodiment, the UE is radio resource control (RRC) connected, and the UE is connected to a first cell in the first radio interface and is connected to a second cell in a second radio interface.

In one embodiment, apparatus 10 may be controlled by memory 14 and processor 22 to send a cell update confirmation to the UE using the second radio interface. According to an embodiment, apparatus 10 may be further controlled by memory 14 and processor 22 to provide the UE with random access channel (RACH) prefix to perform contention-less RACH and to assign an uplink grant that the UE may use to send further radio resource control (RRC) messages to the cell in the first radio interface for completing mobility procedure.

In certain embodiments, the first radio interface may comprise millimeter wave (mmW), centimeter wave (cmW), and/or below 6 gigahertz (B6G), and similarly the second radio interface may comprise millimeter wave (mmW), centimeter wave (cmW), and/or below 6 gigahertz (B6G).

FIG. 3b illustrates an example of an apparatus 20 according to another embodiment. In an embodiment, apparatus 20 may be a node or element in a communications network or associated with such a network, such as a UE. It should be noted that one of ordinary skill in the art would understand that apparatus 20 may include components or features not explicitly shown in FIG. 3b.

As illustrated in FIG. 3b, apparatus 20 includes a processor 32 for processing information and executing instructions or operations. Processor 32 may be any type of general or specific purpose processor. While a single processor 32 is shown in FIG. 3b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device, such as a UE in LTE or LTE-A. In one embodiment, apparatus 10 may be the UE illustrated in FIG. 2 outlined above. According to an embodiment, apparatus 20 may be controlled by memory 34 and processor 32 to, when a new cell is selected according to cell reselection parameters provided in a system information block, send a message to inform the network of cell update via a connection on a first radio interface. In one embodiment, the apparatus 20 is radio resource control (RRC) connected, and the apparatus 20 is connected to a first cell in the first radio interface and is connected to a second cell in a second radio interface. The first radio interface may be millimeter wave (mmW), centimeter wave (cmW), and/or below 6 gigahertz (B6G). Similarly, the second radio interface may be millimeter wave (mmW), centimeter wave (cmW), and/or below 6 gigahertz (B6G).

In one embodiment, apparatus 20 may be controlled by memory 34 and processor 32 to perform cell reselection for mobility on the second radio interface, and to transmit uplink traffic and receive downlink traffic on the first radio interface. According to an embodiment, apparatus 20 may be controlled by memory 34 and processor 32 to receive cell update confirmation from the network using the second radio interface. In another embodiment, apparatus 20 may be controlled by memory 34 and processor 32 to, when informing the network of the cell update, receive random access channel (RACH) prefix to perform contention-less RACH and receive uplink grant to use to send further radio resource control (RRC) messages to the cell in the first radio interface for completing mobility procedure.

According to certain embodiments, when the apparatus 20 is performing cell reselection in the second radio interface, the apparatus 20 is configured to stay in the second radio interface and does not select a cell in another radio interface.

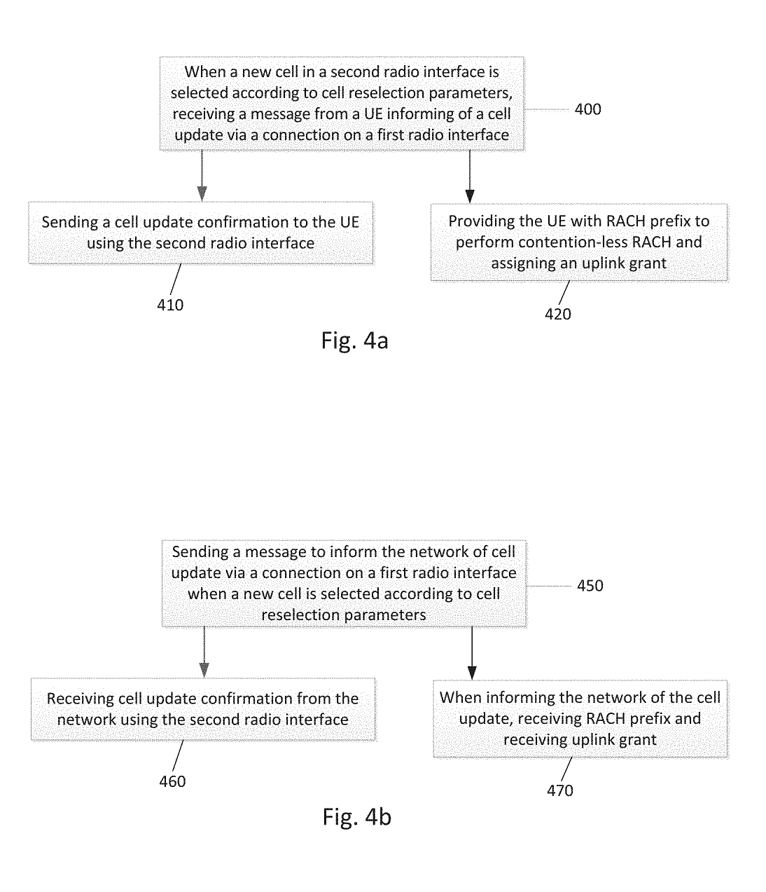

FIG. 4a illustrates an example flow diagram of a method, according to one embodiment. The method of FIG. 4a may be performed by a network node or entity, such as an eNB. The method may include, at 400, receiving a message from a UE informing of a cell update via a connection on a first radio interface, when a new cell is selected according to cell reselection parameters provided in a system information block. In an embodiment, the UE is radio resource control (RRC) connected, and the UE is connected to a first cell in the first radio interface and is connected to a second cell in a second radio interface. In certain embodiments, the first radio interface may comprise millimeter wave (mmW), centimeter wave (cmW), and/or below 6 gigahertz (B6G), and, similarly, the second radio interface may comprise millimeter wave (mmW), centimeter wave (cmW), and/or below 6 gigahertz (B6G).

As illustrated in FIG. 4a, the method may further include, at 410, sending a cell update confirmation to the UE using the second radio interface. Additionally or alternatively, the method may also include, at 420, providing the UE with random access channel (RACH) prefix to perform contention-less RACH and assigning an uplink grant that the UE may use to send further radio resource control (RRC) messages to the cell in the first radio interface for completing mobility procedure.

FIG. 4b illustrates an example flow diagram of a method, according to another embodiment. The method of FIG. 4b may be performed by mobile device, such as a UE. The method may include, at 450, sending a message to inform the network of cell update via a connection on a first radio interface when a new cell on a second radio interface is selected according to cell reselection parameters provided in a system information block. In one embodiment, the UE is radio resource control (RRC) connected, and the UE is connected to a first cell in the first radio interface and is connected to a second cell in a second radio interface. The first radio interface may be millimeter wave (mmW), centimeter wave (cmW), and/or below 6 gigahertz (B6G). Similarly, the second radio interface may be millimeter wave (mmW), centimeter wave (cmW), and/or below 6 gigahertz (B6G).

In one embodiment, the UE may be configured to perform cell reselection for mobility on the second radio interface, and to transmit uplink traffic and receive downlink traffic on the first radio interface. According to an embodiment, the method may further include, at 460, receiving cell update confirmation from the network using the second radio interface. In another embodiment, the method may include at 470, when informing the network of the cell update, receiving random access channel (RACH) prefix to perform contention-less RACH and receiving uplink grant to use to send further radio resource control (RRC) messages to the cell in the first radio interface for completing mobility procedure. According to certain embodiments, when the UE is performing cell reselection in the second radio interface, the UE is configured to stay in the second radio interface and does not select a cell in another radio interface.

Embodiments of the invention provide several advantages and/or technical improvements. As an example, under multi-connectivity scenarios, RI specific mobility is still maintained using active RI resources thereby improving the response time in the inactive RI for new service setup. For instance, the inactive RI does not have to be released but rather could be kept in suspended mode still fulfilling mobility demands. In addition, according to embodiments, the UE behaviour is clear when it is availing different services from different network slices (each RAT could be a new slice, e.g., 3G, 4G and 5G slices).

From the perspective of 3GPP standardization, the following impacts to 3GPP standards are foreseen: define a state per RI, define activation and deactivation rules for the RI and mobility procedure handling when different states are used across RIs (could also be service specific), and provide a generic container to piggyback information for activating/deactivating a RI. For example, the indication of a service targeted towards the dormant RI could be carried to the UE by a container that has all the information that will be passed to the RI handler in the UE. In addition, communication between network slices to indicate UE binding of the UE may be included.

It is noted that embodiments of the invention may be used not only for the informing of the cell reselection, but also fast transition to active state (Cell_DCH) in RI2 either due to UL data or DL data. Whenever UE has uplink data in RI2, it could inform its eNB_RI2 through eNB_RI1, and eNB_RI2 sends necessary information to UE through eNB_RI1, and UE starts in UL without going through costly process of RACH access. A similar mechanism could be used when eNB_RI2 has data for UE.

In some embodiments, the functionality of any of the methods, processes, or flow charts described herein, such as those illustrated in FIGS. 2 and 4, may be implemented by software and/or computer program code or portions of it stored in memory or other computer readable or tangible media, and executed by a processor. In some embodiments, the apparatus may be, included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method comprising:
when a new cell of a second radio interface is selected according to cell reselection parameters provided in a system information block, sending a message, by a user equipment, to inform the network of cell update via a connection on a first radio interface;
wherein the user equipment is radio resource control (RRC) connected, and
wherein the user equipment is connected to a first cell in the first radio interface and is connected to a second cell in the second radio interface.

2. The method according to claim 1, further comprising performing cell reselection for mobility on the second radio interface.

3. The method according to claim 1, further comprising transmitting uplink and receiving downlink traffic on the first radio interface.

4. The method according to claim 1, further comprising receiving cell update confirmation from the network using the second radio interface.

5. The method according to claim 1, further comprising, when informing the network of the cell update, receiving random access channel (RACH) prefix to perform contention-less RACH in the newly selected cell and receiving uplink grant to use to send further radio resource control (RRC) messages to the newly selected cell in the second radio interface for completing mobility procedure.

6. The method according to claim 2, wherein, when the user equipment is performing cell reselection in the second radio interface, the user equipment stays in the second radio interface and does not select a cell in another radio interface.

7. The method according to claim 1, wherein the first radio interface comprises at least one of millimeter wave (mmW), centimeter wave (cmW), and below 6 gigahertz (B6G), and wherein the second radio interface comprises at least one of millimeter wave (mmW), centimeter wave (cmW), and below 6 gigahertz (B6G).

8. The method according to claim 1, wherein the first radio interface and the second radio interface are independently configured.

9. The method according to claim 1, wherein the configuration of the first radio interface and the second radio interface are managed by different entities in the network.

10. The method according to claim 1, wherein the configuration of the first radio interface and the second radio interface are coordinated between different entities in the network.

11. An apparatus, comprising:
at least one processor; and
at least one memory including computer program code,
wherein the at least one memory and computer program code are configured, with the at least one processor, to cause the apparatus at least to
when a new cell of a second radio interface is selected according to cell reselection parameters provided in a system information block, send a message to inform a network of cell update via a connection on a first radio interface;
wherein the apparatus is radio resource control (RRC) connected, and
wherein the apparatus is connected to a first cell in the first radio interface and is connected to a second cell in the second radio interface.

12. The apparatus according to claim 11, wherein the at least one memory and computer program code are configured, with the at least one processor, to cause the apparatus at least to perform cell reselection for mobility on the second radio interface.

13. The apparatus according to claim 11, wherein the at least one memory and computer program code are configured, with the at least one processor, to cause the apparatus at least to transmit uplink traffic and receive downlink traffic on the first radio interface.

14. The apparatus according to claim 11, wherein the at least one memory and computer program code are configured, with the at least one processor, to cause the apparatus at least to receive cell update confirmation from the network using the second radio interface.

15. The apparatus according to claim 11, wherein the at least one memory and computer program code are configured, with the at least one processor, to cause the apparatus at least to, when informing the network of the cell update, receive random access channel (RACH) prefix to perform contention-less RACH in the newly selected cell and receive uplink grant to use to send further radio resource control (RRC) messages to the newly selected cell in the second radio interface for completing mobility procedure.

16. The apparatus according to claim 11, wherein the first radio interface and the second radio interface are independently configured.

17. The apparatus according to claim 11, wherein the configuration of the first radio interface and the second radio interface are managed by different entities in the network.

18. The apparatus according to claim 11, wherein the configuration of the first radio interface and the second radio interface are coordinated between different entities in the network.

19. The apparatus according to claim 12, wherein, when the apparatus is performing cell reselection in the second radio interface, the apparatus is configured to stay in the second radio interface and does not select a cell in another radio interface.

20. A computer program, embodied on a non-transitory computer readable medium, the computer program configured to control a processor to perform a process, comprising:
when a new cell of a second radio interface is selected according to cell reselection parameters provided in a system information block, sending a message, by a user equipment, to inform the network of cell update via a connection on a first radio interface;
wherein the user equipment is radio resource control (RRC) connected, and
wherein the user equipment is connected to a first cell in the first radio interface and is connected to a second cell in the second radio interface.
